(19) United States
(12) Patent Application Publication
(10) Pub. No.: US 2016/0225085 A1
(43) Pub. Date: Aug. 4, 2016

(54) System and Method for Implementing a Dynamic Simulation System

(71) Applicant: TRADING TECHNOLOGIES INTERNATIONAL, INC., CHICAGO, IL (US)

(72) Inventor: Bevan BROOKFIELD, Evanston, IL (US)

(21) Appl. No.: 14/985,568

(22) Filed: Dec. 31, 2015

Related U.S. Application Data
(60) Provisional application No. 62/110,186, filed on Jan. 30, 2015.

(51) Int. Cl. G06Q 40/04

(52) U.S. Cl. CPC G06Q 40/04

(57) ABSTRACT

This patent document discloses a dynamic simulation system. The dynamic simulation system includes: a trading device configured to communicate a user input; a replay device in communication with trading device and including a processor coupled with a memory configured to store instructions. The processor is configured to execute the stored instructions that direct the replay system to analyze a plurality of simulation virtual machines stored in the memory; and a simulation virtual machine identified based on the analysis of the plurality of simulation virtual machines. The simulation virtual machine is associated with the trading device and is configured to determine a delta between received market data at a first time and received market data at a second time, wherein the delta reflects a difference between the market data and a quantity identified in a trade action received from the trading device.

### CROSS REFERENCE TO RELATED APPLICATIONS

This application claims priority to U.S. Provisional Application No. 62/110,186 filed Jan. 30, 2015, which is hereby incorporated by reference in its entirety.

### BACKGROUND

An electronic trading system generally includes a trading device in communication with an electronic exchange. The trading device receives information about a market, such as prices and quantities, from the electronic exchange. The electronic exchange receives messages, such as messages related to orders, from the trading device. The electronic exchange attempts to match quantity of an order with quantity of one or more contra-side orders.

The trading device may provide a trading interface to enable a user to monitor the information about the market and execute trades via the electronic exchange. Some trading interfaces dynamically list prices, bid quantities and/or ask quantities of a tradable object to enable the user to determine a market depth of the tradable object. Any mechanism to provide a review of trading activity may rely on static reports and manual setup.

### BRIEF DESCRIPTION OF THE FIGURES

Exemplary embodiments are disclosed with reference to the following drawings.

FIG. 1 illustrates a block diagram representative of an example electronic trading system in which embodiments may be employed.

FIG. 2 illustrates a block diagram of another example electronic trading system in which embodiments may be employed.

FIG. 3 illustrates a block diagram of an exemplary computing device that may be used to implement the disclosed embodiments.

FIG. 4 depicts an exemplary trading system configured to provide simulation or replay of recorded and/or other non-live market data and/or execution of trades via an exchange in a “normal” or regular trading mode.

FIG. 5 illustrates an exemplary replay or simulation system configured from a trading system used in regular trading of tradable objects on an exchange.

FIG. 6 shows an exemplary replay interface configured to launch and control a trading simulation or replay.

FIG. 7 illustrates an exemplary audit interface provided in conjunction with replay simulation of one or more trading instruments.

Embodiments will be better understood when read in conjunction with the provided figures, which illustrate examples. It should be understood, however, that the embodiments are not limited to the arrangements and instrumentality shown in the attached figures.

### DETAILED DESCRIPTION

The disclosure relates generally to data distribution systems, and more particularly, to systems and methods to simulate and replay actual trading activity in a simulated environment.

Trading devices may be configured to monitor a market for a tradable object, execute trades of the tradable object and/or perform other actions. The electronic exchange communicates market data to the trading device. The trading device stores, organizes, analyzes and/or displays the market data. As the tradable object is traded on the market, the price of the tradable object may move or change (e.g., increase, decrease, fluctuate, etc.).

Market data may be replayed, such as to back test systems, algorithms, and/or trading strategies. Prior attempts to create a test system involve a significant manual setup effort. Prior attempts to create a test system also can only be run on separate, dedicated equipment located on the premises and may be used at times when no ‘real’ and/or real-time activity is occurring in the trading facility. Such systems reduced usefulness and effectiveness of any such test system, while also excluding users not located on the premises in a multi-tenant application service provider (ASP) system.

Prior testing environments required significant expense and/or significant operational restrictions. Setup and configuration of the prior testing environments are often manual, where a new testing environment needed to be created. New testing environments often remained idle when not being used until the environment need to be used. Where the testing environment was based off a production environment, the testing environment could only be used during off hours, or non-trading hours. Great caution also had to be employed when converting back from a testing environment to production to minimize a risk for production trading. In addition, the conversion back to the production system configuration needed to be performed in a timely.

Availability of back test data also can be difficult. In prior approaches, a user must be able to record the data and remember to do so for periods that were desired for replay. Alternatively, the user must systematically record such data, resulting in a significant burden in machine power during the production day, as well as significant consumption of storage (e.g., memory and/or disk) space. Administering such a repository, managing space consumption, archive and discard policies, etc., becomes burdensome, time-consuming, inefficient, and costly. Additionally, such prior manual systems are ineffective in simulating custom trading algorithms, such as those that can be created using graphical interface tools (e.g., ADL® provided by Trading Technologies International, Inc. of Chicago, Ill. (“Trading Technologies”)).

In contrast, exemplary embodiments provide widespread, systematic back/replay testing of tradable objects and trading strategies, including custom algorithms. Exemplary simulator systems that may be set up at any time with minor configuration, may be used at any time, may be charged for by use and/or support replay against standard processes in a trading system stack such as an algorithmic trading server, pre-trade risk, credit risk, ledger and position servers, etc. Examples provide stored market data and accurately simulate real markets using a replay of market data to drive that simulation.

Exemplary replay systems run on a virtual machine, such as a virtual machine in a server farm. The exemplary replay system may utilize standard production versions of trading system components except for a modified market data server, which is modified to accept replay instructions and replay public market data from file or other market data history source.

Exemplary systems and methods may test coding and selection of trade instrument(s) and/or other tradable object(s) for validity and likelihood of success based on prior, recorded market data executed in a production trading environment configured for simulation. As simulation execution continues, examples provide a modified simulation price feed. The modified simulation price feed may adjust the recorded market data price feed based on an effect simulation trade activity is having on the recorded market.

Although examples including, among other components, software executed on hardware, are disclosed, it is noted that the examples are merely illustrative and should are not considered as limiting. For example, it is contemplated that any or all of the hardware and software components may be embodied exclusively in hardware, exclusively in software, exclusively in firmware, or in any combination of hardware, software, and/or firmware. Accordingly, embodiments may be implemented in other ways.

Additionally, while some examples described herein may refer to functions performed by one or more given actors such as “users” and/or other entities, it should be understood that this is for purposes of explanation only. The claims should not be interpreted to require action by any such example actor unless explicitly required by the language of the claims themselves.

### I. Brief Description of Exemplary Embodiments

Exemplary embodiments include a dynamic simulation system. The dynamic simulation system includes: a trading device configured to communicate a user input; a replay device in communication with trading device and including a processor coupled with a memory configured to store instructions. The processor is configured to execute the stored instructions that direct the replay system to analyze a plurality of simulation virtual machines stored in the memory; and a simulation virtual machine identified based on the analysis of the plurality of simulation virtual machines. The simulation virtual machine is associated with the trading device and is configured to determine a delta between received market data at a first time and received market data at a second time, wherein the delta reflects a difference between the market data and a quantity identified in a trade action received from the trading device.

### II. Example Electronic Trading System

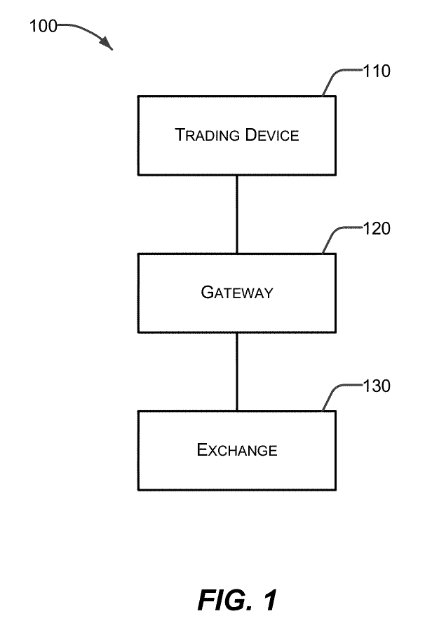

FIG. 1 illustrates a block diagram representative of an exemplary electronic trading system 100 in which exemplary embodiments may be employed. The system 100 includes a trading device 110, a gateway 120, and an exchange 130. The trading device 110 is in communication with the gateway 120. The gateway 120 is in communication with the exchange 130. As used herein, the phrase “in communication with” encompasses direct communication and/or indirect communication. The communications may be through one or more intermediary components. The exemplary electronic trading system 100 depicted in FIG. 1 may be in communication with additional components, subsystems, and elements to provide additional functionality and capabilities without departing from the teaching and disclosure provided herein.

In operation, the trading device 110 may receive market data from the exchange 130 through the gateway 120. The trading device 110 may be used, for example, to monitor the market data and/or for a determination as to whether to send an order message, such as a message to trade (e.g. buy or sell) one or more tradable objects to the exchange 130.

Market data may include data representing market for a tradable object. For example, market data may include at least any one of the inside market, market depth, last traded price (“LTP”), a last traded quantity (“LTQ”), and/or a combinations thereof. The inside market refers to the highest available bid price (best bid) and the lowest available ask price (best ask or best offer) in the market for the tradable object at a particular point in time (since the inside market may vary over time). That is, the best bid and/or the best offer may vary over time, and as such, the inside market varies over time accordingly. Market depth refers to quantities available in the market. For example, the market depth includes the quantity at various price levels including the inside market and away from the inside market. Market depth may have “gaps” such as a price level with no quantity available in the market.

The price levels associated with the inside market and market depth may be provided as value levels such as the price of the tradable object. The price level also or alternatively may be provided with value levels that are derived and/or calculated representations of value. For example, value levels may be displayed as net change from an opening price. As another or additional example, value levels may be provided as a value calculated from prices in two other markets. In another example, value levels may include consolidated price levels.

A tradable object is anything that may be traded at a price for a quantity. For example, a quantity of the tradable object may be bought and/or sold at a price. Tradable objects include, for example, financial products, stocks, options, bonds, future contracts, currency, warrants, funds derivatives, securities, commodities, swaps, interest rate products, index-based products, traded events, goods, and/or a combinations thereof. A tradable object may include real tradable objects such as a product listed and/or administered by an exchange, a synthetic such as user-defined product, a combination of real or synthetic products, and/or combinations thereof. A synthetic tradable object also may correspond and/or is similar to a real tradable object.

An order message is a message that includes a trade order. A trade order may be, for example, a command to place an order to buy or sell a tradable object; a command to initiate managing orders according to a defined trading strategy; a command to change, modify, or cancel an order; an instruction to an electronic exchange relating to an order; and/or combinations thereof.

The trading device 110 may include one or more electronic computing platforms. For example, the trading device 110 may include a desktop computer, hand-held device, laptop, server, a portable computing device, a trading terminal, an embedded trading system, a workstation, an algorithmic trading system such as a “black box” or “grey box” system, cluster of computers, and/or combinations thereof. As another example, the trading device 110 includes a single or multi-core processor in communication with a memory or other storage medium. The processor may be configured to accessibly store one or more computer programs, applications, libraries, computer readable instructions, and the like, for execution by the processor.

As used herein, the phrases “configured to” and “adapted to” represent an element, structure, or device has been modified, arranged, changed, and/or varied to perform a specific function or for a specific purpose.

By way of example, the trading device 110 is implemented as a computing device running a copy of X_TRADER®, an electronic trading platform provided by Trading Technologies. As another example, the trading device 110 may be a server running a trading application providing automated trading tools such as ADL®, AUTOSPREADER®, and/or AUTOTRADER™, also provided by Trading Technologies. In yet another example, the trading device 110 may include a trading terminal in communication with a server, where collectively the trading terminal and the server are the trading device 110.

The trading device 110 is generally owned, operated, controlled, programmed, configured, or otherwise used by a user. As used herein, the phrase “user” may include, but is not limited to, a human (for example, a trader), trading group (for example, a group of traders), or an electronic trading device (for example, an algorithmic trading system). One or more users may be involved in the ownership, operation, control, programming, configuration, or other use.

The trading device 110 may include one or more trading applications. As used herein, a trading application is an application that facilitates or improves electronic trading. A trading application provides one or more electronic trading tools. For example, a trading application stored by a trading device may be executed to receive, arrange and display market data in one or more trading windows. In another example, a trading application may include an automated spread trading application for administering spread trading tools. In yet another example, a trading application may include an algorithmic trading application that automatically processes an algorithm and performs actions, such as placing an order, modifying an existing order, and/or deleting an order. In yet another example, a trading application may provide one or more trading screens. A trading screen may provide one or more trading tools that allow interaction with one or more markets. For example, a trading tool may allow a user to obtain and view market data, set order entry parameters, submit order messages to an exchange, deploy trading algorithms, and/or monitor positions while implementing various trading strategies. The electronic trading tools provided by the trading application may always be available or may be available only in configurations or operating modes of the trading application.

A trading application may be implemented utilizing computer readable instructions that are stored in a computer readable medium and executable by a processor. A computer readable medium may include various types of volatile and non-volatile storage media, including, for example, random access memory, read-only memory, programmable read-only memory, electrically programmable read-only memory, electrically erasable read-only memory, flash memory, any combination thereof, or any other tangible data storage device. As used herein, the term non-transitory or tangible computer readable medium is expressly defined to include any type of computer readable storage media and to exclude propagating signals.

One or more components or modules of a trading application may be loaded into the computer readable medium of the trading device 110, such as from another computer readable medium. For example, the trading application (or updates to the trading application) may be stored by a manufacturer, developer, or publisher of the trading application onto one or more CDs or DVDs, which are then loaded onto the trading device 110 or to a server from which the trading device 110 retrieves the trading application. As another example, the trading device 110 may receive the trading application (or updates to the trading application) from a server, for example, via the Internet and/or an internal network. The trading device 110 may receive the trading application or updates when requested by the trading device 110 (for example, “pull distribution”) and/or un-requested by the trading device 110 (for example, “push distribution”).

The trading device 110 may be adapted to send order messages. For example, the order messages may be sent to through the gateway 120 to the exchange 130. As another example, the trading device 110 may be adapted to send order messages to a simulated exchange in a simulation environment that does not effectuate real-world trades.

The order messages may be sent at the request of a user. For example, a trader may utilize the trading device 110 to send an order message or manually input one or more parameters for a trade order (for example, an order price and/or quantity). As another example, an automated trading tool provided by a trading application may calculate one or more parameters for a trade order and automatically send the order message. In some instances, an automated trading tool may prepare the order message to be sent but not actually send it without confirmation from a user.

An order message may be sent in one or more data packets or through a shared memory system. For example, an order message may be sent from the trading device 110 to the exchange 130 through the gateway 120. The trading device 110 may communicate with the gateway 120 using a local area network, a wide area network, a wireless network, a virtual private network, a cellular network, a peer-to-peer network, a T1 line, a T3 line, an integrated services digital network (“ISDN”) line, a point-of-presence, the Internet, a shared memory system and/or a proprietary network such as TTNET™ provided by Trading Technologies.

The gateway 120 may include one or more electronic computing platforms. For example, the gateway 120 may be implemented as one or more desktop computer, hand-held device, laptop, server, a portable computing device, a trading terminal, an embedded trading system, workstation with a single or multi-core processor, an algorithmic trading system such as a “black box” or “grey box” system, cluster of computers, or any combination thereof.

The gateway 120 may facilitate communication. For example, the gateway 120 may perform protocol translation for data communicated between the trading device 110 and the exchange 130. The gateway 120 may process an order message received from the trading device 110 into a data format understood by the exchange 130. Similarly, the gateway 120 may transform market data in an exchange-specific format received from the exchange 130 into a format understood by the trading device 110.

The gateway 120 may include a trading application, similar to the trading applications discussed above, that facilitates or improves electronic trading. For example, the gateway 120 may include a trading application that tracks orders from the trading device 110 and updates the status of the order based on fill confirmations received from the exchange 130. As another example, the gateway 120 may include a trading application that coalesces market data from the exchange 130 and provides it to the trading device 110. In yet another example, the gateway 120 may include a trading application that provides risk processing, calculates implieds, handles order processing, handles market data processing, and/or combinations thereof.

In exemplary embodiments, the gateway 120 communicates with the exchange 130 using a local area network, a wide area network, a wireless network, a virtual private network, a cellular network, a peer-to-peer network, a T1 line, a T3 line, an ISDN line, a point-of-presence, the Internet, a shared memory system, and/or a proprietary network such as TTNET™ provided by Trading Technologies.

The exchange 130 may be owned, operated, controlled, or used by a third-party entity, such as one or more exchanges of the CME Group, the London International Financial Futures and Options Exchange, the Intercontinental Exchange, and Eurex. The exchange 130 may include an electronic matching system, such as a computer, server, or other computing device, which is adapted to allow tradable objects, for example, offered for trading by the exchange, to be bought and sold at the exchange. The exchange 130 may include separate entities, some of which list and/or administer tradable objects and others which receive and match orders. The exchange 130 may include an electronic communication network (“ECN”).

In an example, the exchange 130 is an electronic exchange adapted to receive electronic order messages for trade orders and to match contra-side trade orders to buy and sell tradable objects. Unmatched trade orders may be listed for trading by the exchange 130, such as in an order book maintained by the electronic exchange for the tradable object. Once an order to buy or sell a tradable object is received and confirmed by the exchange, the order is considered to be a working order until it is filled or cancelled. Where only a portion of the quantity of the order is matched, the matched quantity is removed from the order book and the partially filled order remains a working order. The trade orders may include trade orders received from the trading device 110 or other devices in communication with the exchange 130. For example, typically the exchange 130 will be in communication with a variety of other trading devices (which may be similar to trading device 110) which also provide trade orders to be matched.

The exchange 130 is adapted to provide market data. Market data may be provided in one or more messages or data packets or through a shared memory system. For example, the exchange 130 may publish a data feed, such as to subscribing devices including the trading device 110, gateway 120 data repositories, and data redistributors. The data feed may include market data.

The system 100 may include additional, different, or fewer components. For example, the system 100 may include multiple trading devices, gateways, and/or exchanges. In another example, the system 100 may include other communication devices, such as middleware, firewalls, hubs, switches, routers, servers, exchange-specific communication equipment, modems, security managers, and/or encryption/decryption devices.

### III. Expanded Example Electronic Trading System

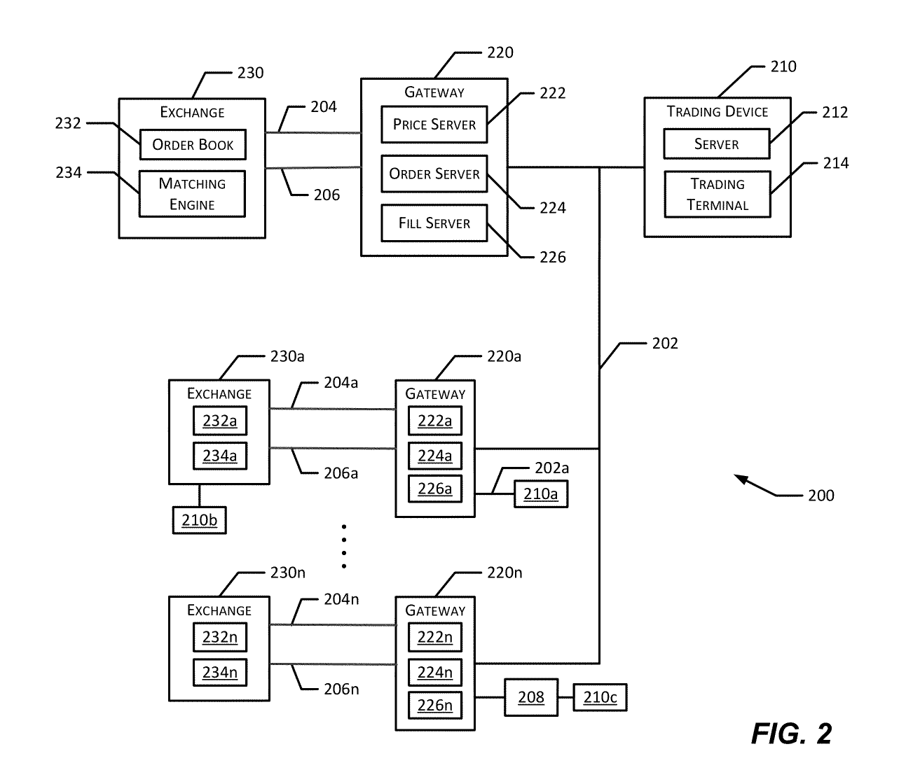

FIG. 2 illustrates a block diagram of another exemplary electronic trading system 200 in which embodiments may be employed. In this example, a trading device 210 utilizes one or more communication networks to communicate with a gateway 220 and exchange 230. For example, the trading device 210 utilizes network 202 to communicate with the gateway 220, and the gateway 220, in turn, utilizes the networks 204 and 206 to communicate with the exchange 230. As used herein, a network facilitates or enables communication between computing devices such as the trading device 210, the gateway 220, and the exchange 230.

The following discussion generally focuses on the trading device 210, gateway 220, and the exchange 230. However, the trading device 210 may also be connected to and communicate with “n” additional gateways (individually identified as gateways 220a-220n, which may be similar to gateway 220) and “n” additional exchanges (individually identified as exchanges 230a-230n, which may be similar to exchange 230) by way of the network 202 (or other similar networks). Additional networks (individually identified as networks 204a-204n and 206a-206n, which may be similar to networks 204 and 206, respectively) may be utilized for communications between the additional gateways and exchanges. The communication between the trading device 210 and each of the additional exchanges 230a-230n need not be the same as the communication between the trading device 210 and exchange 230. Generally, each exchange has its own preferred techniques and/or formats for communicating with a trading device, a gateway, the user, or another exchange. Though shown for simplicity and efficiency, there is not necessarily a one-to-one mapping between gateways 220a-220n and exchanges 230a-230n. For example, a particular gateway may be in communication with more than one exchange. As another example, more than one gateway may be in communication with the same exchange. Such an arrangement may, for example, allow one or more trading devices 210 to trade at more than one exchange (and/or provide redundant connections to multiple exchanges).

Additional trading devices 210a-210n, which may be similar to trading device 210, may be connected to one or more of the gateways 220a-220n and exchanges 230a-230n. For example, the trading device 210a may communicate with the exchange 230a via the gateway 220a and the networks 202a, 204a and 206a. In another example, the trading device 210b may be in direct communication with exchange 230a. In another example, trading device 210c may be in communication with the gateway 220n via an intermediate device 208 such as a proxy, remote host, or WAN router.

The trading device 210, which may be similar to the trading device 110 in FIG. 1, includes a server 212 in communication with a trading terminal 214. The server 212 may be located more proximate to the gateway 220 than the trading terminal 214, such as to reduce latency and/or communication delays. In operation, the trading terminal 214 may provide a trading screen to a user and communicate commands to the server 212 for further processing. For example, a trading algorithm may be deployed to the server 212 for execution based on market data. The server 212 may execute the trading algorithm without further input from the user. In another example, the server 212 may include a trading application providing automated trading tools and communicate back to the trading terminal 214. The trading device 210 may include additional, different, or fewer components.

In operation, the network 202 may be a multicast network configured to allow the trading device 210 to communicate with the gateway 220. Data on the network 202 may be logically separated by subject such as, for example, by prices, orders, or fills. As a result, the server 212 and trading terminal 214 can subscribe to and receive data such as, for example, data relating to prices, orders, or fills, depending on their individual needs.

The gateway 220, which may be similar to the gateway 120 of FIG. 1, may include a price server 222, order server 224, and fill server 226. The gateway 220 may include additional, different, or fewer components. The price server 222 may process price data. Price data includes data related to a market for one or more tradable objects. The order server 224 processes order data. Order data represents information related to a user's trade orders. For example, order data may include order messages, confirmation messages, and/or other types of messages. The fill server collects and provides fill data. Fill data includes data relating to one or more fills of trade orders. For example, the fill server 226 may provide a record of trade orders, which have been routed through the order server 224, that have and have not been filled. The servers 222, 224, and 226 may run on the same machine or separate machines. There may be more than one instance of the price server 222, the order server 224, and/or the fill server 226 for gateway 220. In exemplary embodiments, the additional gateways 220a-220n each include instances of the servers 222, 224, and 226 (individually identified as servers 222a-222n, 224a-224n, and 226a-226n).

The gateway 220 may communicate with the exchange 230 using one or more communication networks. For example, as shown in FIG. 2, there may be two communication networks connecting the gateway 220 and the exchange 230. The network 204 may be used to communicate market data to the price server 222. In some instances, the exchange 230 may include this data in a data feed that is published to subscribing devices. The network 206 may be used to communicate order data to the order server 224 and the fill server 226. The network 206 may also be used to communicate order data from the order server 224 to the exchange 230.

The exchange 230, which may be similar to the exchange 130 of FIG. 1, includes an order book 232 and a matching engine 234. The exchange 230 may include additional, different, or fewer components. The order book 232 is a database that includes data relating to unmatched trade orders that have been submitted to the exchange 230. For example, the order book 232 may include data relating to a market for a tradable object, such as the inside market, market depth at various price levels, the last traded price, and the last traded quantity. The matching engine 234 may match contra-side bids and offers pending in the order book 232. For example, the matching engine 234 may execute one or more matching algorithms that match contra-side bids and offers. A sell order is contra-side to a buy order. Similarly, a buy order is contra-side to a sell order. A matching algorithm may match contra-side bids and offers at the same price. In exemplary embodiments, the additional exchanges 230a-230n each include order books and matching engines (individually identified as the order book 232a-232n and the matching engine 234a-234n, which may be similar to the order book 232 and the matching engine 234, respectively). Different exchanges may use different data structures and algorithms for tracking data related to orders and matching orders.

In operation, the exchange 230 may provide price data from the order book 232 to the price server 222 and order data and/or fill data from the matching engine 234 to the order server 224 and/or the fill server 226. Servers 222, 224, 226 may process and communicate this data to the trading device 210. The trading device 210, for example, using a trading application, may process this data. For example, the data may be displayed to a user. In another example, the data may be utilized in a trading algorithm to determine whether a trade order should be submitted to the exchange 230. The trading device 210 may prepare and send an order message to the exchange 230.

In exemplary embodiments, the gateway 220 is part of the trading device 210. For example, the components of the gateway 220 may be part of the same computing platform as the trading device 210. As another example, the functionality of the gateway 220 may be performed by components of the trading device 210. In exemplary embodiments, the gateway 220 is not present. Such an arrangement may occur, for example, when the trading device 210 does not need to utilize the gateway 220 to communicate with the exchange 230, such as when the trading device 210 has been adapted to communicate directly with the exchange 230 and/or via another intermediary device.

### IV. Exemplary Computing Device

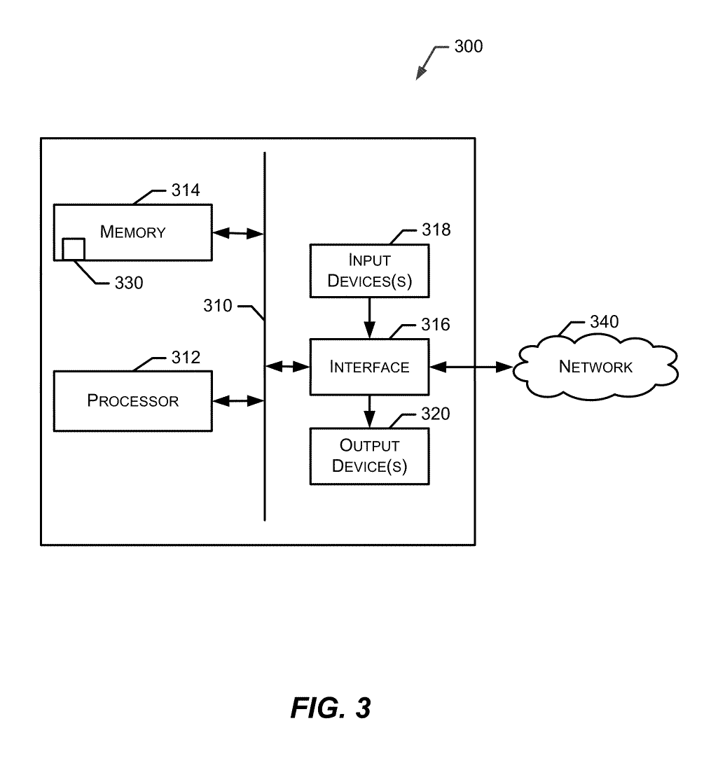

FIG. 3 illustrates a block diagram of an exemplary computing device 300 that may implement the disclosed embodiments. The trading device 110 of FIG. 1 may include one or more computing devices 300. The gateway 120 of FIG. 1 may include one or more computing devices 300. The exchange 130 of FIG. 1 may include one or more computing devices 300.

The computing device 300 includes a communication network 310, a processor 312, a memory 314, an interface 316, an input device 318, and an output device 320. The computing device 300 may include additional, different, or fewer components. For example, multiple communication networks, multiple processors, multiple memory, multiple interfaces, multiple input devices, multiple output devices, or any combination thereof, may be provided. As another example, the computing device 300 may not include an input device 318 or output device 320.

As shown in FIG. 3, the computing device 300 may include a processor 312 coupled to a communication network 310. The communication network 310 may include a communication bus, channel, electrical or optical network, circuit, switch, fabric, or other mechanism for communicating data between components in the computing device 300. The communication network 310 may be communicatively coupled with and transfer data between any of the components of the computing device 300.

The processor 312 may be any suitable processor, processing unit, or microprocessor. The processor 312 may include one or more general processors, digital signal processors, application specific integrated circuits, field programmable gate arrays, analog circuits, digital circuits, programmed processors, and/or combinations thereof. The processor 312 may be a single device or a combination of devices, such as one or more devices associated with a network or distributed processing. Any processing strategy may be used, such as multi-processing, multi-tasking, parallel processing, and/or remote processing. Processing may be local or remote and may be moved from one processor to another processor. In exemplary embodiments, the computing device 300 is a multi-processor system and, thus, may include one or more additional processors which are communicatively coupled to the communication network 310.

The processor 312 may be operable to execute logic and other computer readable instructions encoded in one or more tangible media, such as the memory 314. As used herein, logic encoded in one or more tangible media includes instructions that may be executable by the processor 312 or a different processor. The logic may be stored as part of software, hardware, integrated circuits, firmware, and/or micro-code. The logic may be received from an external communication device via a communication network such as the network 340. The processor 312 may execute the logic to perform the functions, acts, or tasks illustrated in the figures or described herein.

The memory 314 may be one or more tangible media, such as computer readable storage media. Computer readable storage media may include various types of volatile and non-volatile storage media, including, for example, random access memory, read-only memory, programmable read-only memory, electrically programmable read-only memory, electrically erasable read-only memory, flash memory, any combination thereof, or any other tangible data storage device. As used herein, the term non-transitory or tangible computer readable medium is expressly defined to include any type of computer readable medium and to exclude propagating signals. The memory 314 may include any desired type of mass storage device including hard disk drives, optical media, magnetic tape or disk, etc.

The memory 314 may include one or more memory devices. For example, the memory 314 may include local memory, a mass storage device, volatile memory, non-volatile memory, and/or combinations thereof. The memory 314 may be adjacent to, part of, programmed with, networked with, and/or remote from processor 312. The data stored in the memory 314 may be retrieved and processed by the processor 312. The memory 314 may store instructions which are executable by the processor 312. The instructions may be executed to perform one or more of the acts or functions described herein or shown in the figures.

The memory 314 may store a trading application 330. In exemplary embodiments, the trading application 330 may be accessed from or stored in different locations. The processor 312 may access the trading application 330 stored in the memory 314 and execute computer-readable instructions included in the trading application 330.

In exemplary embodiments, during an installation process, the trading application may be transferred from the input device 318 and/or the network 340 to the memory 314. When the computing device 300 is running or preparing to run the trading application 330, the processor 312 may retrieve the instructions from the memory 314 via the communication network 310.

### V. Exemplary System and Method for Implementing a Dynamic Simulation System

Exemplary improved simulation systems and methods utilizing production systems, real trading settings, and real trading data are provided. The examples facilitate dynamic, “real time” trading simulation that tracks and maintains an effect of simulated trades with respect to underlying recorded market data.

Exemplary embodiments provide more accurate simulated trading of one or more tradable objects by tracking liquidity reduction continuously in a simulated market. The simulated trading facilitates large-scale, network-based (e.g., cloud-based) trading replay and simulation applying one or more trading strategies from one or more traders to real, recorded market data to monitor, record, analyze, and compare resulting impact on the market and its liquidity.

Market data may be organized according to a plurality of levels (or price tiers), the depth and/or detail of market data. For example, each successive level (e.g., level one, level two, level three, etc.) may include values that indicate more detail or additional information regarding the market data beyond the detail provided at prior levels. In an example, Data also or alternatively may be partitioned into multiple levels for update, simulation, etc.

In some examples, the data levels are organized in descending levels of interest (e.g., a first level of data includes most requested data, and a second level includes second most requested data, etc.). Additionally or alternatively, each data level may represent a level of information detail. Each data level is partitionable or may be separated from the data levels below. That is, data is ordered into levels or tiers such that recipients may specify a preference to receive only a subset of the levels, beginning with a first data level and cumulatively through a preferred data level. For example, some recipients may prefer to receive the first three data levels while other recipients may prefer to receive only the first data level. Some recipients may desire only information in the fifth data level, for example, but, in accordance with the partitionable data levels technique, such recipients are willing to also receive levels above their desired data level (in this example, levels one through four). Examples also include embodiments where each data level may include multiple data values.

Prior market simulation that administered test trading against a “real” market (either live or recorded) modeled a market based on market data and allowing users to place orders “against” that market, where the orders may trade if market conditions allow. An approach would use only level one data (e.g., a first level of market depth or detail) and allow the user to place an order that either trades immediately in full if marketable, or rests and then trades if the market moves. Order size is not considered, nor is impact on market liquidity (e.g., impact of a successfully executed order on ease of filling other present orders, future orders, etc.).

Other approaches model an entire market depth and user orders within that depth, with an estimation of an order's place in a queue at the order's price tier in the market. When orders are placed that cross the market (e.g., bid prices exceed ask prices), rules of an exchange being modeled (e.g., first-in first-out (FIFO) (e.g., price and time are used as criteria to fill an order), Pro-Rata (e.g., fill orders according to price, order size, and time), Pro-Rata with priority (e.g., Pro-Rata but the first incoming order that betters the market gets priority), etc.) are used to remove liquidity from the simulation market, and user orders may then get partially or fully filled.

However, even when the market is correctly modeled in full depth in such simulations, once there is a quote update, any liquidity removed by simulated trading is replaced at the end of time priority queues. Thus, effect on liquidity from trades in the prior simulation systems is not realistic because the effect is gone as soon as an update is received. Using such simulations, it is impossible to accurately simulate liquidity replacement that may result if the trade had actually happened in the real market, but some replacement is likely. For example, iceberg orders (e.g., a large order divided into multiple smaller parts such that only a portion of the order is visible at a time) or algorithmic trades (e.g., electronic trading via an algorithm that executes pre-programmed trading instructions based on one or more variables including timing, price and/or order quantity, also referred to as “algo” trading or black-box trading) may refresh some of that liquidity, and/or other traders may react to the trade prints by placing new orders.

Additionally, it is not realistic in an open-ended simulation to keep track of liquidity reduction resulting from simulated trading and to continuously re-apply the liquidity reduction over the market depth data. However, running some trading algorithms or trading strategies in a simulator may give inaccurate results due to the overoptimistic approach of allowing liquidity to refresh as soon as the market depth quote refreshes. Permanently reducing the liquidity is a better approach, even if, as noted above, it does not model the liquidity replacement that may happen in a real market.

### Example Replay Simulation System

Rather than providing a separate, manual setup for trading simulation or “back testing” on dedicated on-premise equipment, examples facilitate dynamic, flexible simulation for one or more users in a multi-tenant application service provider (ASP) system. An ASP system may be facilitated regardless of whether the simulation is occurring separately and/or concurrently with “actual” trading activity. Examples provide simulation of custom trading algorithms on a trading system that is easy to configure, easy to execute In an example, a trading system may be arranged to provide systematic back/replay testing of one or more tradable objects (e.g., trading strategies including multiple tradable objects). The system may use standard processes in a trading system stack such as algorithm server, pre-trade risk, credit risk, ledger, and position sever, etc. As configured, the replay system accurately simulates a real market using a replay of recorded or otherwise buffered market data to drive the simulation or “replay”.

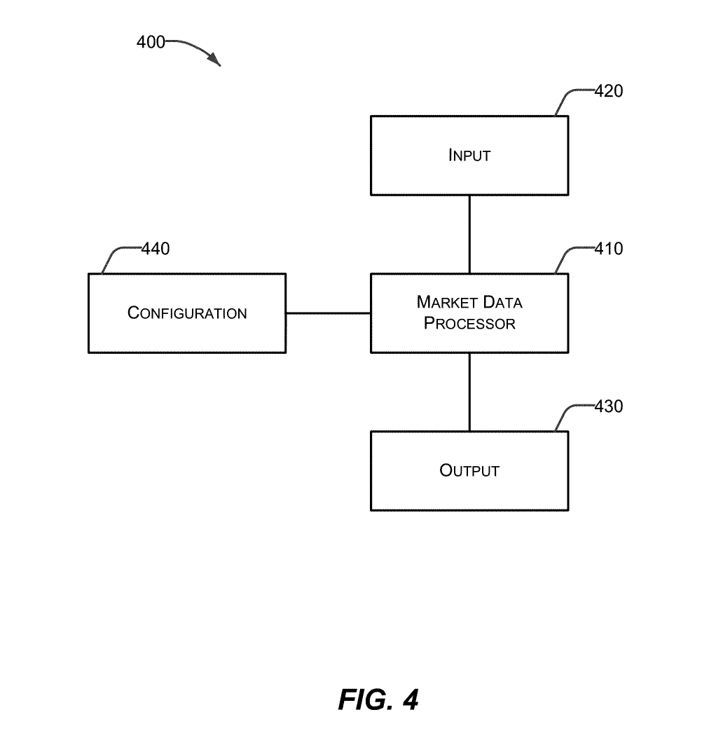

FIG. 4 depicts an exemplary trading system 400 which is configured to provide simulation or replay of recorded and/or other non-live market data as well as execution of trades via an exchange in a “normal” or regular trading mode. The exemplary replay system 400 includes a market data processor 410, input 420, output 430, and configuration 440. The market data processor 410 operates on input data received via the input 420 according to settings, parameters, and/or other instructions provided by the configuration 440. Result(s) of operating on the input data are provided to the output 430.

For example, the configuration 440 indicates an operational mode of the trading system 400. The trading system 400 can operate in a normal trading mode or a simulation mode. Identifying the mode of operation may dictate how the trading system operates. For example, the configuration 440 can specify an image of a production trading system configured in a normal trading mode, simulation mode, etc., to run on a virtual machine using input 420 such as live market data from an exchange, previously recorded market data, analytic input, trading algorithmic input, etc. Live and/or saved market data may be provided as a data stream, snapshot, delta, etc., via input 420 to the trading system 400.

The market data processor 410 facilitates actual and/or simulated trading activity based on the current and/or recorded market data input and one or more trade actions such as trading algorithm(s), other trading strategy(-ies), individual tradable object(s), etc. For example, a simulated trade action is implemented for a tradable object with respect to first recorded market data to generate second market data. The second market data may be generated based on an impact of the simulated trade action on the first market data. In an example, where the system is in simulation mode, the market data processor 410 may adjust a speed to simulated trade action (e.g., slow down and/or speed up passage of time within the simulation/replay, etc.).

A result of a trade action is provided to the output 430 The result may be sent to exchange for processing and execution in a normal trading mode or executed within the simulation by the market data processor 410 in simulation mode. In an example, a delta resulting from the trade action is determined with respect to the recorded market data by the market data processor 410 and provided as output 430.

A log of trade actions and market data movement, whether in normal mode or in simulation, can also be provided as output 430. Logging or stored trading activity may be flagged or tagged as normal trade activity, simulated trade activity, etc., and normal trade activity may be logged separately from simulated trade activity so as not to invite confusion between actual trading results and simulated trading results. In simulated trading mode, the determined delta may be saved with the trade activity data to enable update of displayed simulation market data and smooth continuation of the trading simulation/replay. In an example, the delta resulting from the simulated trade action is provided as an overlay to be applied to displayed market data via a trading interface (e.g., a trading interface associated with the input 420 and/or output 430).

As real or simulated trading activity continues, updated market data may be received as input 420 and processed by the market data processor 410 according to the configuration 440. An updated trading algorithm, other trading strategy, etc., can also be received and processed by the market data processor 410 for real and/or simulated trading. Updates are reflected in a trading interface displayed for trader interaction. In an example, a difference or delta introduced by the simulation may be applied to market data updates to help ensure that simulation trade effects are maintained and/or otherwise propagated during the course of the simulation to more accurately judge trade effects and/or outcomes in the simulation/replay.

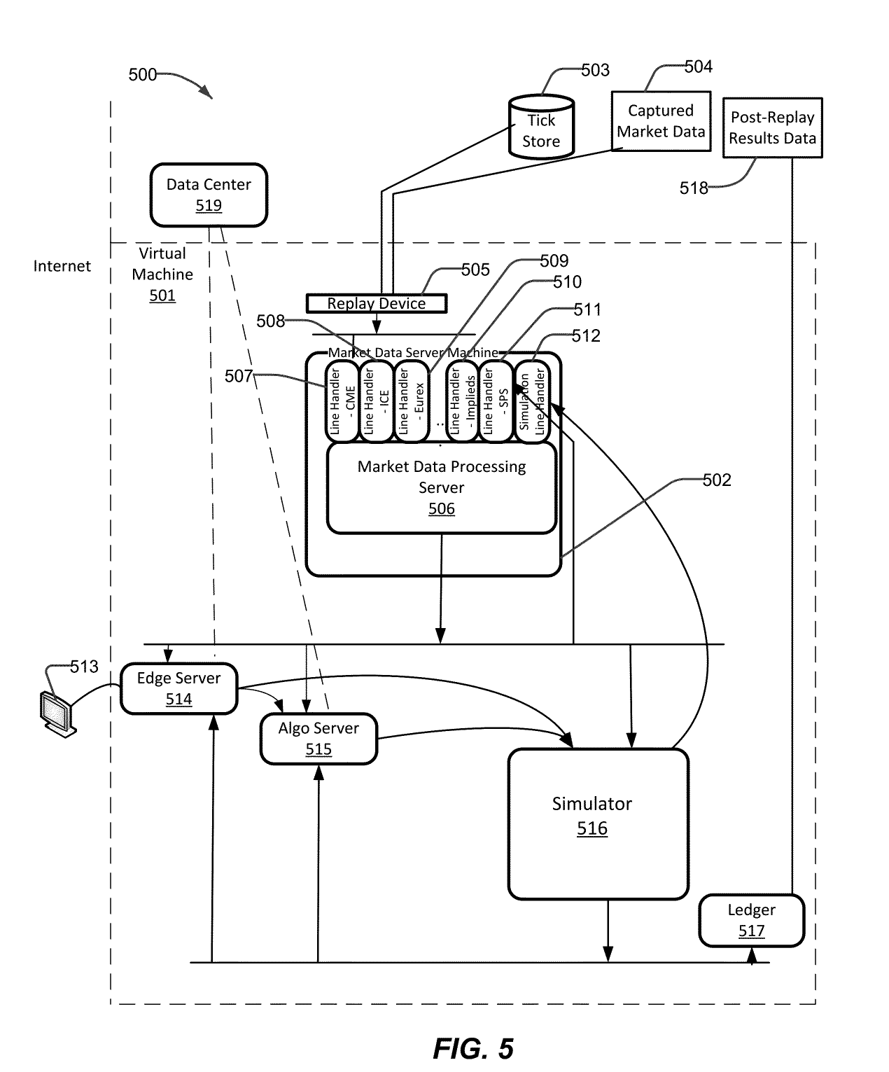

FIG. 5 illustrates an exemplary replay or simulation system 500 configured from a trading system, such as trading system 210, used in regular trading of tradable objects on an exchange (e.g., exchange 230). As shown in the example of FIG. 5, the replay system 500 is designed to execute a multiple-piece trading server farm on a single virtual machine (VM) 501. Components of the replay system 500 function as they would in normal exchange trading, except for a market data server machine 502, which is modified to accept replay instructions and replay public market data from a file and/or other market data history source (e.g., market data from a tick store 503, raw market data capture files 504, etc., provided to the market data server machine 502 via a replay device 505).

In operation, an available VM 501 may be ordered up, selected, chosen, or otherwise requested from a group of VMs. For example, a plurality of VMs may be running in a public cloud and available. The VM's may be available in various sizes and/or configurations. In an example, the VM's may be offered at an hourly and/or other incremental rate. The identified VM 501 is exclusive to the requester and an associated market replay for a specified duration and remains running until closed (e.g., by the user, by an end to the specified duration, etc.). In an example, ordering or requesting a VM 501 for simulation or replay instantiates a replay machine or simulator and triggers a request for recorded market data from one or more sources 503, 504 via the replay device 505. The replay device 505 may be a software and/or hardware front end to request and format data for the market data processor 502 when in simulation mode. The market data has been recorded or otherwise saved for a specified duration from a specified or predetermined start time to a specified or predetermined end time.

Once the replay machine 501 is created, market data is requested and pulled from one or more file or tick database source(s) 503, 504. As shown in the example of FIG. 5, the market data server machine 502 includes a market data processing server 506 as well as one or more handlers 507-512 to accommodate data feeds (e.g., exchanges such as CME, ICE, Eurex, etc.; instruments such as implieds, synthetic instruments, etc.; and simulation trade activity) into the market data processing server 506. For example, standard instrument price data 507-509, implieds data 510, synthetic instrument data 511, and simulation/replay feed 512 handlers translate, format, and/or distribute data to the market data processing server 506. The market data processing server 506 may be an image of a production market data processing server 506 modified to accept replay instructions, The market data processing server 506 also or alternatively may utilize simulation results and recorded market data 504 via the replay device 505 and simulation feed handler 512.

In an example, level two data is provided for replay/simulation. In response to an amount data being preloaded and buffered, simulation may be initiated. The simulation may be initiated by providing data from the market data processing server 506 to a simulator 516. The simulator 516, may act as an exchange for purposes of the simulation/replay. Trading algorithms and/or other trading strategies may be instantiated, for example, by pointing a trading device 513 to an address (e.g., an Internet Protocol (IP) address) of the simulator VM 501 and connecting (e.g., via Web Socket) the trading device 513 to an edge server 514 on that virtual machine 501. The trading device 513 can also be used to view the replay/simulation via edge server 514.

For example, the edge server 514 can communicate with an algo server 515 to provide one or more trading algorithms and/or other trading strategy to the simulator 516. The simulator 516 operates on market data received from the market data processing server 506 based on the trading algo(s) provided by the algo server 515. The trading device 513 may communicate with the edge server 514 to display results of the trading algorithm working in real time or substantially real time including a processing, memory access, and/or transmission latency delay.

Replay of market data may involve taking buffered or otherwise stored market data for replay and pushing the data out through a market data processing server 506. The data may be pushed out through the market data processing server 506 as if the data were actual, real-time market data from an exchange. A replay or simulation driver 516 uses time synchronization data in conjunction with the market replay data to simulate a market data flow at a correct time offset. For example, where a simulation or replay is of market data buffered from 9:00 am to 4:00 pm and the replay of that buffered market data begins at 1:01:02 pm in the afternoon, events happening at 9:01 am in the market data recording are to be replayed at 1:02:02 pm in the simulation so as to maintain a correct time offset, scale, or relationship.

In an example, a speed of replay may be sped up and/or slowed down, but time relationships within the altered-speed replay are still maintained. For example, where a bid for a tradable object ABC comes thirty (30) minutes before an ask for the tradable object ABC in the buffered market data recording and the replay speed is increased such that one minute of recorded data is replayed in thirty seconds, then the bid for tradable object ABC comes fifteen (15) minutes before the ask for tradable object ABC in the replay simulation. Thus, a trading algorithm or other trading strategy may be replayed at a multiple of real time, rather than at hardcoded times of day.

In operation, the market data being replayed emerges from the market replay data processing server 506 as standard price multicast data. As part of the replay simulator 516, the multicast may be received within the VM 501 only and cannot escape the VM 501 (e.g., so as not to accidentally reach a real market exchange or other normal trading actor). All subscribing processes receive the multicast of replay market data simultaneously (or at least substantially simultaneously given some transmission, memory access, and/or processing delay). For example, the algo server 515 and the market simulator 516 receive the replay market data multicast. Synthetic price feeds based on real market data can feed off the multicast and generate their results for feedback through the market data processing server 506 in real-time (or substantially real-time given some transmission, memory access, and/or processing delay) without separately recording the synthetic price data. Synthetic price data feed(s) can include structured product (SP) synthetic trading instruments, implied prices, and simulation price feed for private simulation quotes and trades.

In an example, one or more VMs may be configured for a given simulation based on a number of replayed instruments and trading strategies (e.g., algorithms, etc.) to be run. For example, multiple VMs may be set up for a simulation to avoid overloading a single machine 501 for the replay.

### Example Replay System Logistics

In an example, VMs may be implemented using a public or private cloud system (e.g. Amazon Web Services (AWS), vCloud, etc.). The cloud system may have configurable virtual machine options. One or more predefined images may be created in the cloud system. Each image may include an entire system stack, plus a replay-specific driver process. A production trading system stack may be captured in an image (e.g., stored in a data center 519), and driver(s) for the replay simulation also included in that image. The image may be instantiated in a VM 501 such that the VM is configured as a production trading system including replay operations (e.g., a delta-based simulation using a recorded market data feed, etc.). The configured VM 501 also provides accessible storage for level (e.g., level 2, level 3, etc.) market data (e.g., a file-based replay of market data from storage, market data requested instrument by instrument from an analytic server, etc.).

Alternatively or in addition, data may be replayed through an application service provider (ASP) system using new trading instrument names specific to a replay. By providing separate names, replay data may be segregated from real-time data. By switching the trading instruments on orders to match, the actions of trading algorithms in response to the replay data are sent to the trading exchange simulator rather than to real market exchange(s). However, using the ASP approach may negatively impact real market resource availability and performance as well as complicating a provider's ability to charge a user for computing resource usage.

In an example, a replay user may order, select or otherwise request a VM 501 running in a public cloud. The cloud system may provide the VM, such as via a lease for a period of time. The selected virtual machine 501 is exclusive to the requesting replay user and the user's replay. The selected VM 501 remains running until the user closes the VM 501 or the replay completes. As part of the VM 501 ordering process, market data from one or more tradable objects may be requested for a time period designated by a start time and an end time.

In response to the replay machine 501 being created, market data (e.g., level two data) may be requested and pulled in from a tick database source 503 (e.g., OneTick™, etc.) and/or other recorded data store 504. Market data may be delivered in chunks of arbitrary size, followed by a done signal. By decoding response timestamps, progress in a requested timespan may be evaluated. In an example, an initial snapshot of market depth is followed by time-stamped delta data specifying changes at price tier levels.

In response to sufficient data being preloaded and buffered, the replay via the simulator 516 may be initiated. The user can instantiate one or more trading algorithms and/or other trading strategies prior to the start of the replay. The trading algorithms and/or other trading strategies may be instantiated by directed a trading interface 513 to an address (e.g., an IP address) of the replay VM 501 and connecting to that VM 501 at that address (e.g., connecting via Web Socket to an edge server 501 on the replay VM 501). The connected trading interface 513 (e.g., a TT™ via the edge server) can then be used to view the replay including results of the trading algorithm from the algo server 515 working in real-time (or substantially real-time given some transmission, memory access, and/or processing delay).

### Replay Ordering and Configuration Examples

In an example, a replay may be requested by requesting a replay of one or more trading strategies over a set period time (e.g., from a start of a minute to an end of a minute). A VM (e.g., VM 501) sufficient to handle a load of replayed trading instruments, trading algorithms, and/or other trading strategies in simulation is selected. In an example, a user interface to order a replay may be implemented as a widget panel in a trading interface (e.g., TT™ window, etc.). Based on a number of trading instruments selected, the interface suggests a virtual machine size to accommodate execution of the simulation replay.

In an example, one or more trading instruments may be selected to be replayed manually. Additionally or alternatively, algos or synthetic spreads may be selected to run (associated instruments then come from their configurations, such as provided by an algo server). Once the replay is requested (and its configuration and pricing are confirmed), representational state transfer (REST) calls and/or other architectural abstraction are used to instantiate the virtual machine (e.g., VM 501) with the required image in an appropriate datacenter. In the example of FIG. 5, once the VM 501 is created and an associated IP address is returned, the trading interface on the trading device 513 can connect to the edge server 514 on the virtual machine 501. Via the edge server 514 and in conjunction with the algo server 515, the price replay device or simulator 516 is primed with one or more instruments for trading and an associated time span to replay.

In an example, a trader can control the replay, start, stop, rewind to start, etc., using a special control widget in the trading interface. Users can request speeds faster than real-time for the replay. For more accurate results, trading algos do not use set time delays or elapsed time measurements from a system clock that do not scale the same way as the time speed increase. In addition the speed up replay should not be set to overload the simulation system given the particular trading algos running and number of instruments involved. In an example of FIG. 5, by using process quotas with an operating system of the VM 501, a “fast as possible” mode may be allowed in simulation, which will run the replay as fast as the market data processing server 506 and simulator 516 can operate within their quota, while still allowing processing resource availability for the other components.

In an example, a replay or other simulation can only realistically run at a multiple of a real-time speed before the sender or receivers become overloaded, thereby limiting the number of serial back tests that may be done in a given period. However, to determine a best set of parameters for a trading algo, it may be desirable to run multiple copies of the algorithm each with a different parameter set (e.g., a parallel monte carlo simulation, etc.). Different identifiers may be assigned to different simulations so that each simulation does not interfere with the other, thereby segregating each algorithm's simulated matching and price feedback.

In an example, a trader can configure an average latency for each market center. The average latency can then be implemented as a minimum response latency on an order to acknowledge and quote.

In an example, enduring liquidity reduction is provided. For example, since back-test simulations are of defined and limited duration, a more realistic variant of market simulation provides that, where liquidity is removed from the market, the liquidity remains removed even when price depth is updated. The simulator 516 maintains a liquidity impairment delta at each price tier for a duration of the replay, which can reduce an effective volume at that tier to zero at minimum. The liquidity impairment delta then represents a most pessimistic view of the simulation's effect on market liquidity, where liquidity removed is never replaced by iceberg orders, or other market participants reacting to trade activity by placing new liquidity into the market(s), etc. For some trading strategies, enduring liquidity reduction may increase accuracy. The simulator 516 provides the liquidity reduction delta as part of the simulation replay data provided to handler 512, which translates and distributes the simulation data as with other price updates via the market data processing server 506.

Additionally, the simulator 516 can broadcast an execution report. The execution report may be provided to a ledger 517 to generate an output of post-replay results data 518 for reporting, auditing, analytics, and/or other feedback. The simulator's 516 execution report can also be provided to a source such as the algo server 515 providing trading algorithm(s), other strategy(-ies), etc.

Thus, using the VM 501 configured with simulator 516 providing modified data to the market data server machine 502, coding and selection of trade instrument(s) and/or other tradable object(s) may be tested for validity and likelihood of success based on prior, recorded market data executed in a production trading environment configured for simulation. As simulation execution continues, examples provide a modified simulation price feed which adjusts the recorded market data price feed based on an effect simulation trade activity is having on the recorded market.

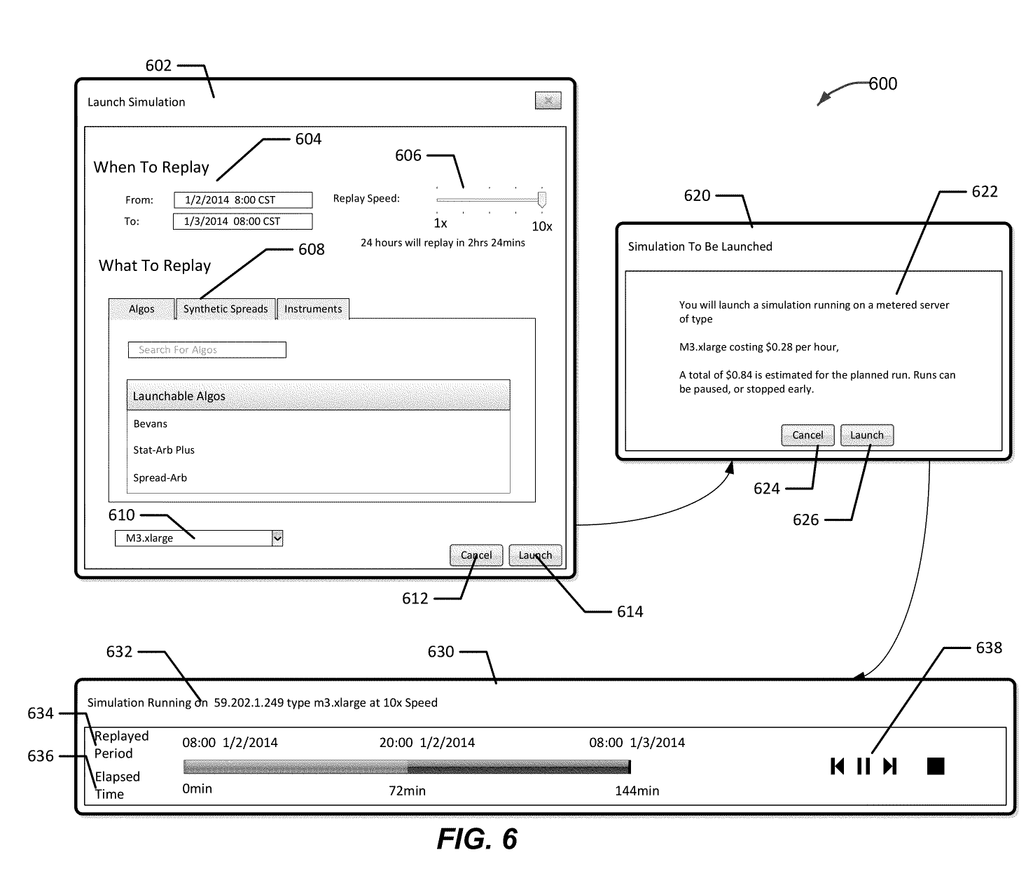

FIG. 6 shows a replay interface 600 for controlling a replay/simulation. For example, one or more controls may be provided to facilitate movement through a trading simulation such as start, stop, rewind, etc. The replay controls may be provided using a special control widget in a trading interface such as TT™ provided by Trading Technologies. As shown in the example of FIG. 6, a simulation may be initiated via a launch control 602. The launch control 602 includes a time period selector 604 allowing a user to specify a start (e.g., starting date and time) and end (e.g., ending date and time) to the simulation replay period. The launch control 602 also includes a replay speed selector 606 which allows the user to set the replay at normal or “real life” speed (e.g., 1×) or at a multiple of real life speed (e.g., at a speed of 10× which replays twenty-four hours in two hours and twenty-four minutes).

The launch control 602 also allows the user to specify 608 which instruments, trading strategies (e.g., algos, synthetic spreads, etc.), and/or other tradable objects to replay. For example, via the trading instrument selector 608, the user selects one or more instruments to be replayed either directly or by selecting spreads and/or trading algorithms to which the user has access and which have configured lists of instruments already associated with them.

FIG. 6 shows the launch control 602. The launch control may be used to select a server 610 to execute the replay. In response to configuration options being set for the simulation, the launch control 602 may facilitate cancellation 612 or launch 614 of the replay simulation. In the example of FIG. 6, a confirmation box 620 is generated via the trading interface to confirm 622 that the simulation is to run on a metered server. The confirmation box also or alternatively may confirm a cost for an estimated total. The user may cancel 624 or launch 626 the simulation. In an example, this confirmation screen 620 is not displayed. Rather, the simulation is launch upon initiation via 614 in the primary launch control 602.

During simulation, a status and control interface 630 may be provided via the trading interface. The status and control interface 630 may be positioned adjacent to a trading window in which the trading simulation is executing. Via the status and control interface 630, configuration information 632 for the currently running simulation is displayed. Additionally, the total replay period 634 as well as a currently elapsed time 636 of the simulation is shown in the example of FIG. 6. Further, one or more replay controls 638 are provided to allow the user to pause, stop, rewind, fast forward, play, etc., the current simulation.

### Example Risk, Audit and Post Replay Analysis

A replay or simulation uses same user credentials and environment as a trader or other user launching the replay. In an example, data is sourced using REST services accessible in the VM machine in the cloud. Examples have limited scope for risk, and pre-trade risk limits may be established.

Audit capability may be provided in the simulation/replay environment, and audit records may be made visible in real-time (or substantially in real-time accounting for some processing, storage/access, and/or transmission delay). Audit records may be stored in external storage for later viewing after the replay has ended. In an example, profit and loss (P&L) tracking is available during the replay and is written to audit at the end as a special record.

In an example, an audit trail that results from SIM trading done during a replay session is recorded in external storage so that the audit trail is visible after the replay has been performed by a special viewer. This viewer allows searching for replays, displaying the data with timestamp adjustment (e.g., a delta of seconds, etc.) to match the time of the market data replayed, etc. In an example, a version of a Ledger process is used to capture data to external storage segmented by user and replay session.

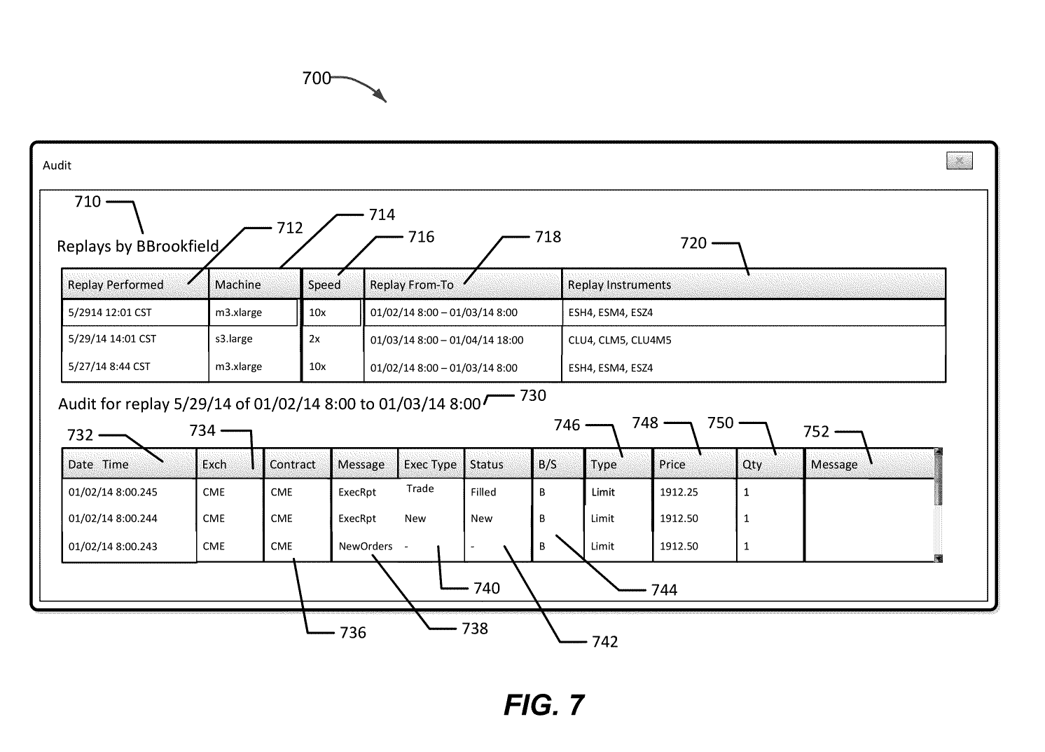

FIG. 7 illustrates an exemplary audit interface 700 provided in conjunction with replay simulation of one or more trading instruments. The audit interface 700 includes a listing of replays 710, such as a listing of replays by user. The available replays 710 are displayed according to time of replay 712, machine used for replay 714, replay speed 716, replay time period 718, and instrument(s) involved in the replay simulation 720.

Audit interface 700 also provides an audit log 730 for a selected replay from the list of replays 710. For the selected replay, the audit log 730 shows a series of trade actions in the selected replay. As shown in the example of FIG. 7, the audit log 730 includes a date and time of each trade action by the user, and exchange 734 and contract 736 impacted by the trade action. A message 738 associated with the trade action as well as its execution type 740 and status 742 are also provided. Further detail such as well the action is a buy or sell 744, a type of order 744 (e.g., a limit order, etc.), a price 748, and a quantity 750 are also provided. As shown in the example interface 700, a message field 752 is also provided to allow other messages about a trade action to be saved with the audit record. Thus, a reviewer can see the series of available replays, select a replay for further review, and view the audit log of actions which occurred during the replay.

In an example, upon completion of a replay/simulation, the virtual machine providing the simulation is released (e.g., destroyed and/or otherwise freed up for other use). While the simulation results can persist in storage for review and analysis via audit log, P&L affect analysis, etc., the VM vehicle for the simulation does not persist. Simulation data may be stored in a same format and same storage and regular trading data, for example, but should be stored separately so as not to comingle normal and simulation trading data.

Some of the described figures depict example block diagrams, systems, and/or flow diagrams representative of methods that may be used to implement all or part of exemplary embodiments. One or more of the components, elements, blocks, and/or functionality of the example block diagrams, systems, and/or flow diagrams may be implemented alone or in combination in hardware, firmware, discrete logic, as a set of computer readable instructions stored on a tangible computer readable medium, and/or any combinations thereof.

The example block diagrams, systems, and/or flow diagrams may be implemented using any combination of application specific integrated circuit(s) (ASIC(s)), programmable logic device(s) (PLD(s)), field programmable logic device(s) (FPLD(s)), discrete logic, hardware, and/or firmware. Also, some or all of the exemplary methods may be implemented manually or in combination with the foregoing techniques.

The example block diagrams, systems, and/or flow diagrams may be performed using one or more processors, controllers, and/or other processing devices. For example, the examples may be implemented using coded instructions, for example, computer readable instructions, stored on a tangible computer readable medium. A tangible computer readable medium may include various types of volatile and non-volatile storage media, including, for example, random access memory (RAM), read-only memory (ROM), programmable read-only memory (PROM), electrically programmable read-only memory (EPROM), electrically erasable read-only memory (EEPROM), flash memory, a hard disk drive, optical media, magnetic tape, a file server, any other tangible data storage device, or any combination thereof. The tangible computer readable medium is non-transitory.

Further, although the example block diagrams, systems, and/or flow diagrams are described above with reference to the figures, other implementations may be employed. For example, the order of execution of the components, elements, blocks, and/or functionality may be changed and/or some of the components, elements, blocks, and/or functionality described may be changed, eliminated, sub-divided, or combined. Additionally, any or all of the components, elements, blocks, and/or functionality may be performed sequentially and/or in parallel by, for example, separate processing threads, processors, devices, discrete logic, and/or circuits.

While embodiments have been disclosed, various changes may be made and equivalents may be substituted. In addition, many modifications may be made to adapt a particular situation or material. Therefore, it is intended that the disclosed technology not be limited to the particular embodiments disclosed, but will include all embodiments falling within the scope of the appended claims.

What is claimed is:

1. A dynamic simulation system comprising:
a trading device configured to communicate a user input;
a replay system in communication with trading device, the replay system including a processor coupled with a memory configured to store instructions, and wherein the processor is configured to execute the stored instruction that direct the replay system to:
analyze a plurality of simulation virtual machines in response to a received user input, wherein the simulation virtual machine are stored in memory included in the replay system; and
monitor each of the plurality of simulation virtual machines in accordance with a replay metric;
a simulation virtual machine identified based on the analysis of the plurality of simulation virtual machines, wherein the simulation virtual machine is associated with the trading device and wherein the simulation virtual machine is configured to:
receive a trade order from the trading device, wherein the trade order identifies a tradable object, a price and a quantity;
receive market data from a stored state source, wherein the market date is associated with the tradable object identified in the trade order;
determine a delta between the market data at a first time and the market data at a second time, wherein the delta reflects a difference between the market data and the quantity identified in the trade action, and wherein the delta is determined utilizing the processor included in the replay system.

2. The system of claim 1, wherein the replay metric is selected from the group consisting of: a virtual machine configuration, virtual machine size, an incremental rate, an hourly rate, and a usage rate.

3. The system of claim 1, wherein monitor each of the plurality of simulation virtual machines further comprising:
generating a usage log for each of the plurality of simulation virtual machines.

4. The system of claim 1 further comprising:
a second simulation virtual machine identified based on the analysis of the plurality of simulation virtual machines, wherein the second simulation virtual machine is associated with the trading device and wherein the simulation virtual machine is configured to:
identify a second tradable object in the received trade order, wherein the trade order identifies a price and a quantity associated with the second tradable object;
receive market data from the stored state source, wherein the market date is associated with the second tradable object identified in the trade order;
determine a second delta associated with the second tradable object, wherein the second delta is between the market data at the first time and the market data at the second time and reflects a difference between the market data and the quantity identified in the trade action, and wherein the delta is determined utilizing the processor included in the replay system.
